(19) United States
(12) Patent Application Publication
(10) Pub. No.: US 2009/0026173 A1
(43) Pub. Date: Jan. 29, 2009

(54) METHOD AND APPARATUS FOR WELDING AN ARTICLE

(75) Inventors: Michael Douglas Arnett, Simpsonville, SC (US); Daniel Anthony Nowak, Greenville, SC (US)

Correspondence Address: CANTOR COLBURN, LLP, 20 Church Street, 22nd Floor, Hartford, CT, 06103, US

(73) Assignee: General Electric Company, Schenectady, NY (US)

(21) Appl. No.: 11/828,702

(22) Filed: Jul. 26, 2007

(51) Int. Cl. B23K 9/16; B23K 9/00

(52) U.S. Cl. 219/74; 219/72

(57) ABSTRACT

Disclosed is a method for welding an article, the method including the steps of placing the article in an enclosure with walls that enclose the article on all sides, the enclosure having a heating device associated therewith, the heating device configured and sized to uniformly heat the article over at least a substantial entirety of the article, establishing a nonreactive atmosphere in the enclosure, operating the heating device to uniformly heat the article in the enclosure to a welding temperature over at least the substantial entirety of the article, and welding the article in the enclosure while maintaining the welding temperature over at least the substantial entirety of the article.

### FIELD OF THE INVENTION

The disclosure relates generally to a method and apparatus for welding, and more particularly to a method and apparatus for welding a superalloy article.

### BACKGROUND OF THE INVENTION

Nickel, cobalt, and iron based superalloys high in aluminum and titanium content have a strong tendency to crack when welded, particularly when filler wire of similar chemistry is used. In order to overcome this tendency, repairs (via welding) on superalloy parts have been performed by locally pre-heating the area to be repaired to extremely high temperatures (often greater than 1500 degrees F) in an inert gas atmosphere. This local pre-heating method has been effective when used prior to and during a welding of parts with non-complex geometries, such as the rotating hot gas path parts of industrial gas turbines.

Historically, parts with complex geometries, such as the turbine nozzles used in industrial gas turbines, have been made from more readily weldable alloys than the superalloys referred to above. Theses more readily weldable alloys allowed the complex geometric parts to receive significant weld repairs during both manufacture and after engine operation.

Recently, nickel, cobalt, and iron based superalloys have started to be used in hot gas path parts including complex geometries. However, the local pre-heating method discussed above has not been effective when used to heat these parts before and during welding. This is because local pre-heating methods can lead to large thermal gradients in the part. When this local pre-heating is applied, the residual stresses and complex geometries of the parts combine with the large thermal gradients to produce new cracks in the parts before any welding can be performed.

Accordingly, with the higher gamma prime alloys now being used for parts with complex geometries, a new welding methodology would be desirable.

### SUMMARY OF THE INVENTION

Disclosed is a method for welding an article, the method including the steps of placing the article in an enclosure with walls that enclose the article on all sides, the enclosure having a heating device associated therewith, the heating device configured and sized to uniformly heat the article over at least a substantial entirety of the article, establishing a nonreactive atmosphere in the enclosure, operating the heating device to uniformly heat the article in the enclosure to a welding temperature over at least the substantial entirety of the article, and welding the article in the enclosure while maintaining the welding temperature over at least the substantial entirety of the article.

Also disclosed is an apparatus for welding an article, the apparatus including an enclosure adapted for containing the article, the enclosure having walls for enclosing the article on all sides, a heating device disposed within the enclosure, the heating device being configured to heat the article to welding temperature over at least a substantial entirety of the article, and a welding device disposed within the enclosure, the welding device being configured to weld the article while the article is within the enclosure and the article is at the welding temperature.

### BRIEF DESCRIPTION OF THE DRAWINGS

The following descriptions should not be considered limiting in any way. With reference to the accompanying drawings, like elements are numbered alike:

FIG. 1 is a schematic representation of an apparatus for welding an article;

FIG. 2 is a block diagram illustrating a method for welding an article; and

FIG. 3 is a schematic representation of the article of FIG. 1.

### DETAILED DESCRIPTION OF THE INVENTION

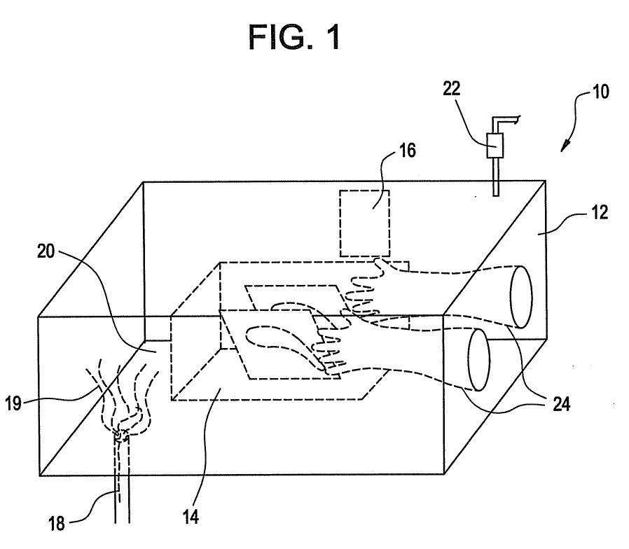

An apparatus 10 for welding a metal article 11 (such as a superalloy metal article) is schematically illustrated in FIG. 1. The apparatus 10 includes an enclosure 12, a heating device 14 that is thermally isolated from the enclosure 12, and a welding device 16. The enclosure 12 includes walls that are configured to seal and enclose the article 11 on all sides. The heating device 14 is sized and configured to uniformly heat the entire article (or at least a substantial entirety of the article 11), and may be any desirable heating device, such as but not limited to an induction heating device, a conductive heating device, and a radiant heating device. In conjunction with the enclosure 12, the welding device 16 is configured for performing a welding operation, such as but not limited to tungsten inert gas (TIG) welding, plasma transferred arc (PTA) welding, or laser welding. The filler metal used by the welding device 16 may be any form of a wire that is appropriate for the operating environment of the article 11. In an exemplary embodiment, the filler metal includes similar properties and chemistry to that of the article 11.

The enclosure 12 also includes a gas inlet 18 through which an inert gas 19 is fed from an exterior of the enclosure 12. Presence of this inert gas 19 within the enclosure 12 creates an inert atmosphere 20 that envelops the article 11 while the article 11 is heated to and maintained at a desired welding temperature. In an exemplary embodiment, the desired welding temperature is at or greater than about 1500 degrees Fahrenheit, and the inert gas used is argon. A one-way flow control valve 22 is shown attached to one wall of the enclosure 12, through which the inert gas 19 and fumes can be exhausted from the enclosure 12 while preventing air from being drawn into the enclosure 12. With the exception of the gas inlet 18 and the one-way flow control valve 22, the enclosure 12 is configured to be sealed off from an ambient environment surrounding the enclosure 12, allowing the article 11 to be sealed within the inert atmosphere during heating and welding.

The apparatus 10 further includes a manipulator 24 for the welding device 16 and article 11. The manipulator 24 may be glove box or pair of gloves comprising a material capable of tolerating the temperatures reached in the enclosure 12. The manipulator 24 is attached to one of the walls of the enclosure 12 so that the article 11 being welded and/or the welding device 16 can be manipulated within the enclosure 12. As a result, with the exception of the one-way valve 22, the enclosure 12 is configured to remain sealed while the article 11 is being heated to or at the welding temperature. Sealing the enclosure 12 in this manner prevents ambient air from being drawn into the enclosure 12 due to severe thermal gradients or other potential causes.

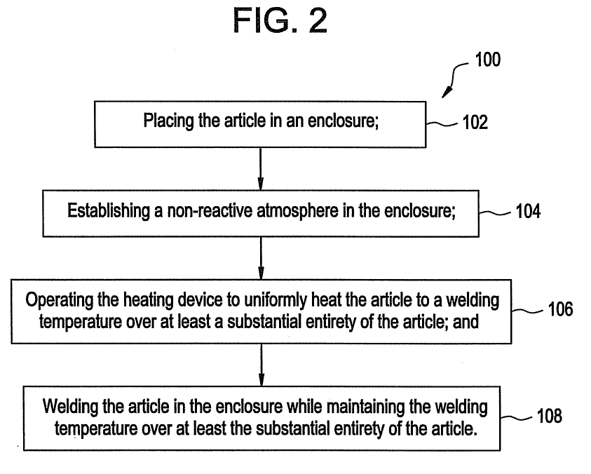

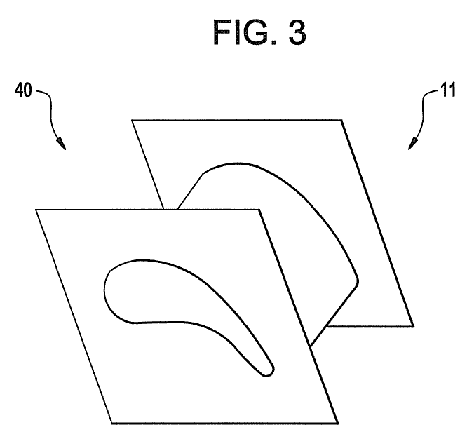

Referring now to FIG. 2, an exemplary method 100 for welding a article will be described with reference to the numbered elements introduced above. The method 100 includes placing an article 11 in an enclosure 12, as is shown in operational block 102. In an exemplary embodiment the article 11 is a turbine nozzle 11 with a complex geometry 40 (such as that shown in FIG. 3). For purposes of this disclosure, an article (such as article 11 of FIG. 3) with a complex geometry will be generally defined as an article with inconsistent, varying dimensions over at least a portion of the article (i.e., an article including different respective lengths, widths, or heights at different regions of the article).

The method 100 also includes establishing a non-reactive atmosphere 20 in the enclosure 12, as shown in operational block 104. As shown in operational block 106, the method 100 further includes operating the heating device 14 to uniformly heat the article 11 to a welding temperature over at least a substantial entirety of the article 11, wherein the entirety of the article is best shown in FIG. 3. This operating occurs without removing the article 11 from the enclosure. Heating the article 11 to the welding temperature without removing the article 11 from the enclosure 12 allows a relaxing of residual stresses present in the article 11 as a result of the severe conditions in which the article 11 operates. In addition, uniformly heating the entirety of the article 11 to the welding temperature eliminates thermal gradients associated with localized heating of the article. Elimination of these gradients further decreases or eliminates cracking in the article 11 caused by the gradients. With this cracking remedied, the method 100 is allowed to proceed to a welding of the article 11, as shown in operational block 108, wherein the welding occurs while maintaining the welding temperature over at least a substantial entirety 44 of the article 11. It should be appreciated that in an exemplary embodiment, the welding temperature is at or greater than about 1500 degrees Fahrenheit.

It will be noted that while the method 100 has been described with reference to components of gas turbine engines (i.e. the turbine nozzle 11 best shown in FIG. 3), the method 100 is also applicable to a variety of applications in which an article (particularly an article with a complex geometry) is to be heat treated for welding in a manner that will not degrade the properties of the article.

It will also be noted that while the invention has been described with reference to an exemplary embodiment, it should be understood by those skilled in the art that various changes may be made and equivalents may be substituted for elements thereof without departing from the scope of the invention. In addition, many modifications may be made to adapt a particular situation or substance to the teachings of the invention without departing from the scope thereof. Therefore, it is important that the invention not be limited to the particular embodiment disclosed as the best mode contemplated for carrying out this invention, but that the invention will include all embodiments falling within the scope of the apportioned claims. Moreover, it will be further noted that unless specifically stated any use of the terms first, second, etc. do not denote any order or importance, but rather the terms first, second, etc. are used to distinguish one element from another.

What is claimed is:

1. A method for welding an article, the method comprising the steps of:
placing the article in an enclosure with walls that enclose the article on all sides, said enclosure having a heating device associated therewith, said heating device configured and sized to uniformly heat the article over at least a substantial entirety of the article;
establishing a nonreactive atmosphere in said enclosure;
operating said heating device to uniformly heat the article in said enclosure to a welding temperature over at least said substantial entirety of the article; and
welding the article in said enclosure while maintaining said welding temperature over at least said substantial entirety of the article.

2. A method according to claim 1, wherein said welding is performed with a welding device manipulated by a manipulator attached to walls of said enclosure.

3. The method according to claim 1, wherein said welding temperature is greater than or equal to about 1500 degrees Fahrenheit.

4. A method according to claim 1, wherein the heating device is at least one of an induction heating device, a conductive heating device, and a radiant heating device.

5. The method according to claim 1, wherein said welding device is at least one of a tungsten inert gas (TIG) welding device, an arc welding device, and a laser welding device.

6. The method according to claim 1, wherein the article is configured for use as a component of a gas turbine engine, said component including a complex geometry.

7. The method according to claim 1, wherein the article is configured for use as a turbine nozzle of a gas turbine engine.

8. The method of claim 1, further including flowing an inert gas into said enclosure via a gas inlet.

9. The method of claim 8, further including allowing a venting of said inert gas from said enclosure via a one-way flow control, said one-way control valve being configured to prevent air from entering said enclosure during said venting.

10. The method of claim 9, wherein said inert gas is argon.

11. An apparatus for welding an article, the apparatus comprising:
an enclosure adapted for containing the article, said enclosure having walls for enclosing the article on all sides;
a heating device disposed within said enclosure, said heating device being configured to heat the article to welding temperature over at least a substantial entirety of the article; and
a welding device disposed within said enclosure, said welding device being configured to weld the article while the article is within the enclosure and the article is at said welding temperature.

12. The apparatus of claim 11, wherein a glove box is attached to the enclosure, said glove box being configured to allow a user to manipulate said welding device and the article within said enclosure.

13. The apparatus according to claim 11, wherein said welding temperature is greater than or equal to about 1500 degrees Fahrenheit.

14. The apparatus according to claim 11, wherein said heating device is at least one of an induction heating device, a conductive heating device, and a radiant heating device.

15. The apparatus according to claim 11, wherein said welding device is at least one of a tungsten inert gas (TIG) welding device and an arc welding device.

16. The apparatus according to claim 11, wherein the article is configured for use as a component of a gas turbine engine, said component including a complex geometry.

17. The apparatus according to claim 11, wherein the article is configured for use as a turbine nozzle of a gas turbine engine.

18. The apparatus of claim 11, wherein said enclosure includes a gas inlet configured to allow an inert gas to flow into said enclosure.

19. The apparatus of claim 11, wherein said enclosure includes a one-way flow control valve that is configured to prevent air from being drawn into said enclosure by thermal gradients induced when the article is heated, said one way flow control valve being configured to vent gases from the enclosure.

20. The apparatus of claim 11, wherein said enclosure is sealed with the exception of a gas inlet and a one-way flow control valve.
